(19) United States
(12) Patent Application Publication
(10) Pub. No.: US 2025/0153617 A1
(43) Pub. Date: May 15, 2025

(54) PIVOT JOINT BSR MITIGATION ELEMENT

(71) Applicant: Brose Fahrzeugteile SE & Co. Kommanditgesellschaft, Coburg, Coburg (DE)

(72) Inventor: Anthony FERENC, Goodrich, MI (US)

(73) Assignee: Brose Fahrzeugteile SE & Co. Kommanditgesellschaft, Coburg, Coburg (DE)

(21) Appl. No.: 18/510,617

(22) Filed: Nov. 15, 2023

(51) Int. Cl. B60N 2/12

(52) U.S. Cl. CPC B60N 2/12

(57) ABSTRACT

A seat adjustment mechanism of a vehicle seat includes a four-bar link and a bracket. The four-bar link includes an input link, an intermediate link, an output link and a fixed link. The bracket includes a body having a surface, a pivot hole extending through the body and configured to receive a shoulder bolt for connecting the bracket to the seat adjustment mechanism, a dimple formed on the surface adjacent to the pivot hole and a coined region formed around the dimple.

### BACKGROUND OF THE INVENTION

### Field of the Invention

The present invention relates to a vehicle seat adjustment mechanism and, in particular, a vehicle seat adjustment mechanism configured to mitigate noise related to buzz, squeaks and rattles (BSR).

### Description of the Background Art

Automotive vehicles include seat assemblies for occupants in the vehicle. Each seat assembly typically includes a generally horizontal seat cushion attached to a generally vertical seat back. Vehicle seat assemblies are typically configured to be adjustable. That is, typical vehicle seat assemblies are configured to allow a user to adjust the height of the seat assembly, to pivot the seat back relative to the seat cushion to allow a passenger to recline, and to adjust the seat assembly horizontally forward and backward. The different seat adjustments can be made manually, by actuating one or more levels, or by a powered motor assembly.

Minimizing noise is a common challenge automotive engineers face when designing vehicles. With the shift from loud internal combustion engines (ICE) to quiet electric motor drive trains, any buzz, squeaks and rattles (BSR) from vehicle components, especially those within a vehicle interior, are more noticeable to passengers. A noisy component can annoy passengers or may raise concern with passengers that something is wrong with the vehicle. BSR is often a result of friction between two components and can be found in a variety of vehicle components including vehicle seat adjustment mechanisms.

For example, FIGS. 1a and 1b illustrate a conventional bracket for attaching a seat adjustment mechanism to a vehicle seat. The bracket 1 has a main body 2 having a through-hole 3 configured to receive a shoulder bolt 4, which attaches the bracket 1 to an input link 5 of the seat adjustment mechanism. A dimple 6 is formed adjacent to the through hole 3. The dimple 6 is provided to mitigate BSR during seat adjustments. A potential issue with this conventional design is the potential for a clamping condition under the shoulder 7 of the shoulder bolt. This clamping condition can cause the shoulder bolt 4 to not rotate with the input link 5, which can cause the shoulder bolt 4 to loose. Additionally, the clamping condition could make it more difficult rotate the input link 5.

### SUMMARY OF THE INVENTION

In view of the foregoing, and other, exemplary problems, drawbacks and disadvantages of conventional seat adjustment mechanisms, it is an object of the present invention to reduce or eliminate unwanted noise generated by buzz, squeaks and rattles (BSR) during adjustment of a vehicle seat while also avoiding a clamping condition around the shoulder bolt.

To achieve the above and other features, in a first, exemplary, non-limiting aspect of the present invention, a bracket for a seat adjustment mechanism of a vehicle seat includes a body having a surface, a pivot hole extending through the body and configured to receive a shoulder bolt for connecting the bracket to the seat adjustment mechanism, a dimple formed on the surface adjacent to the pivot hole and a coined region formed around the dimple.

In a second, exemplary, non-limiting aspect of the present invention, a seat adjustment mechanism of a vehicle seat includes a four-bar link and a bracket. The four bar link includes an input link, an intermediate link, an output link and a fixed link. The bracket includes a body having a surface, a pivot hole extending through the body and configured to receive a shoulder bolt for connecting the bracket to the seat adjustment mechanism, a dimple formed on the surface adjacent to the pivot hole and a coined region formed around the dimple.

In a third, exemplary, non-limiting aspect of the present invention, a vehicle seat includes a seat adjustment mechanism including a four-bar link and a bracket. The four-bar link includes an input link, an intermediate link, an output link and a fixed link. The bracket includes a body having a surface, a pivot hole extending through the body and configured to receive a shoulder bolt for connecting the bracket to the seat adjustment mechanism, a dimple formed on the surface adjacent to the pivot hole and a coined region formed around the dimple.

In accordance with the above, exemplary aspects of the present invention, a vehicle seat adjustment mechanism is provided in which unwanted noise generated by buzz, squeaks and rattles (BSR) during adjustment of a vehicle seat is mitigated while also avoiding a clamping condition around the shoulder bolt.

Further scope of applicability of the present invention will become apparent from the detailed description given hereinafter. However, it should be understood that the detailed description and specific examples are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIGS. 1a and 1b illustrate a conventional bracket of a seat adjustment mechanism;

FIG. 2 illustrates an exemplary automotive vehicle;

FIG. 3 illustrates an exemplary vehicle seat of the automotive vehicle;

FIG. 4 illustrates an exemplary seat adjustment mechanism for the vehicle seat;

FIGS. 5 and 6 illustrate general schematic illustrations of a four-bar linkage;

FIG. 7 illustrates an exemplary bracket of the seat adjustment mechanism;

FIG. 8 illustrates a cross-sectional view of the bracket secured to a link of the four bar linkage;

FIG. 9 further illustrates the bracket secured to a link of the four bar linkage; and

FIG. 10 illustrates another exemplary bracket of the seat adjustment mechanism.

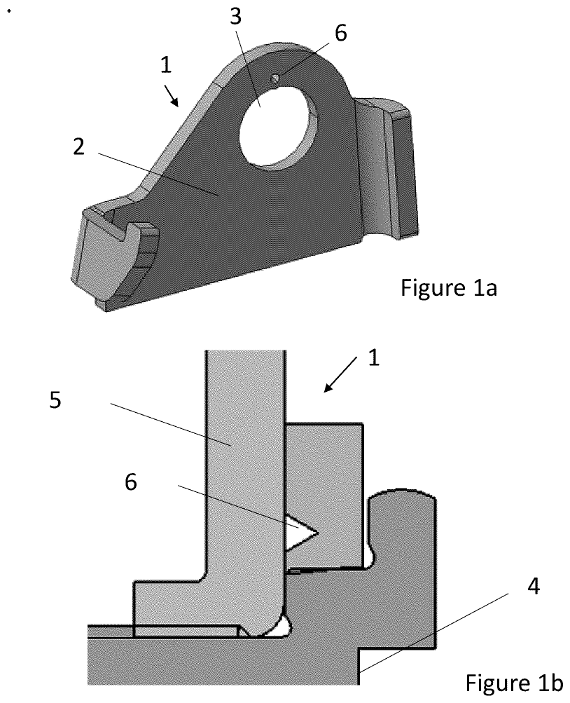

### DETAILED DESCRIPTION

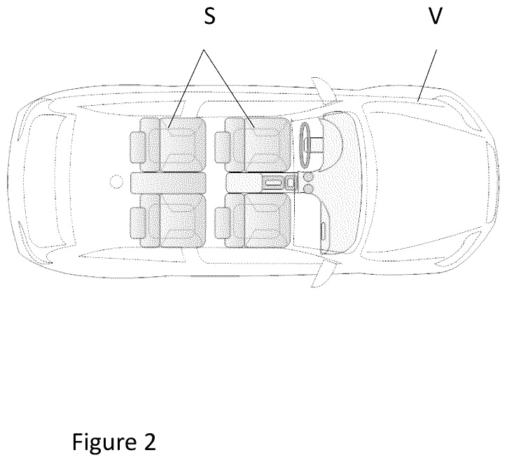

FIG. 2 illustrates an automotive vehicle V. The vehicle V includes at least one vehicle seat S. In the example illustrated in FIG. 2, the vehicle V includes a plurality of seats S arranged in rows.

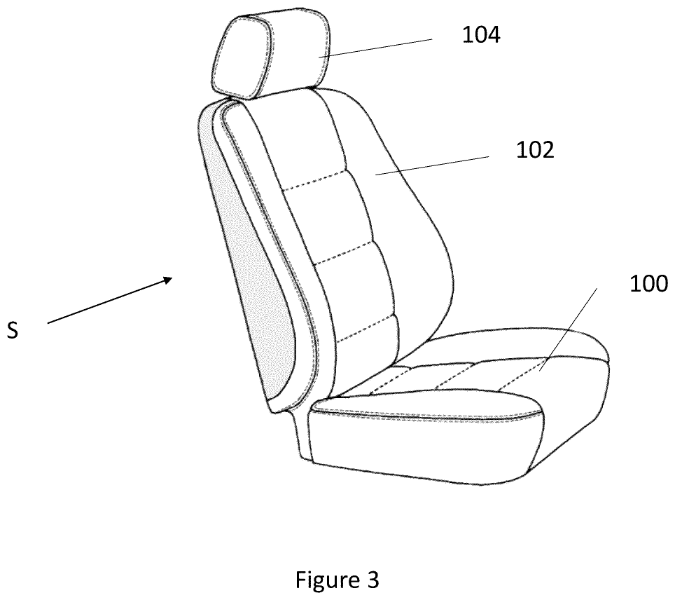

FIG. 3 illustrates an exemplary vehicle seat S of the automotive vehicle V. The vehicle seat S essentially includes a generally, horizontally arranged seat cushion 100, configured to support a passenger's legs when seated, a generally, vertically arranged seat back 102 configured to support a passenger's back when seated and a head rest 104 configured to support a passenger's head when seated.

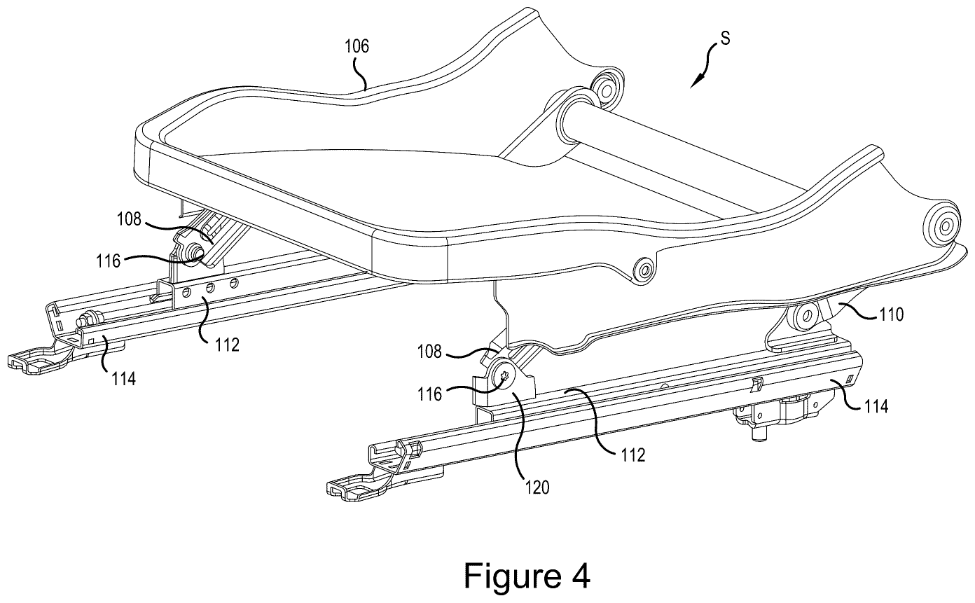

FIG. 4 illustrates an exemplary seat adjustment mechanism for the vehicle seat S. The seat adjustment mechanism includes a four-bar link on each sided of the seat. Each four-bar link includes a seat cushion frame 106, which supports the generally, horizontally arranged seat cushion 100, a rear link 108, a front link 110, and a fixed rail 112. Each fixed rail 112 is slibably received within a guide rail 114, which is secured to a floor within the interior of the vehicle V. The rear link 108 and the front link 110 are pivotably attached to the fixed rail 112 by a bracket 120. The design of each four-bar link, on each side of the seat, is the same.

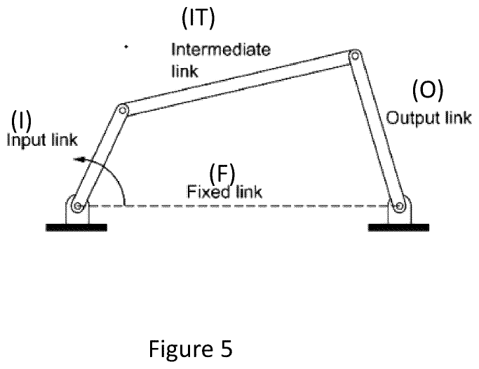

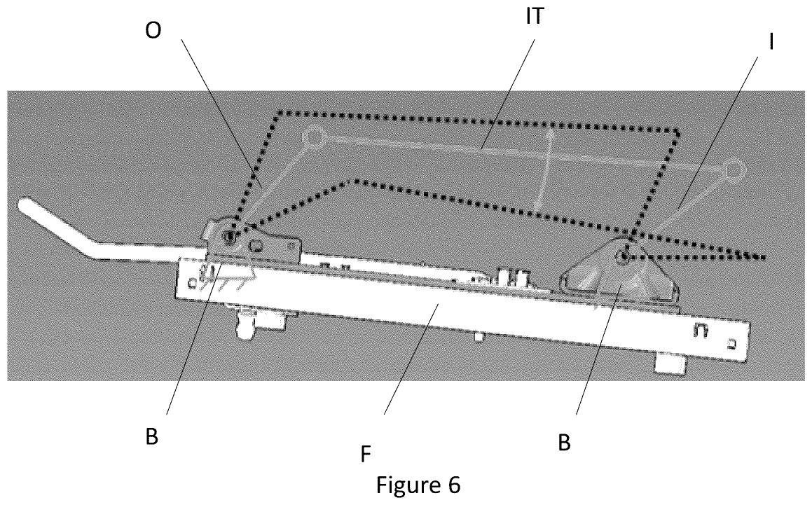

FIGS. 5 and 6 illustrate general schematic illustrations of a four-bar link. In general, a four-bar link includes an input link I (corresponding to the rear link 108), an intermediate link IT (corresponding to the seat cushion frame 106), an output link O (corresponding to the front link 110) and a fixed link F (corresponding to the fixed rail 112). FIG. 6 illustrates how the input link I and the output link O are pivotably mounted on the fixed link F by brackets B and how the four-bar link moves when actuated.

When the four-bar link is pivoted, the seat cushion frame 106, the front link 110 and the rear link 108 are pivoted in the same direction. Thus, depending on the direction in which the four-bar link is pivoted, the front end and the rear end of the seat cushion 100 are raised or lowered.

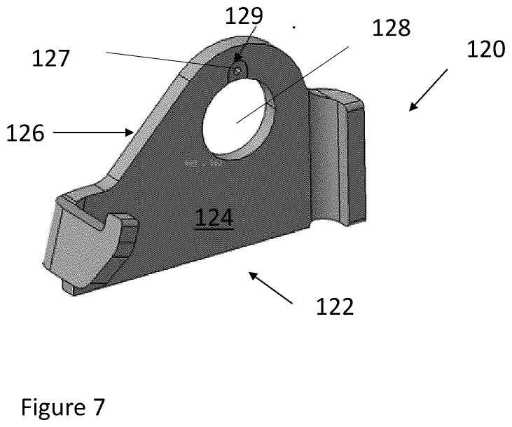

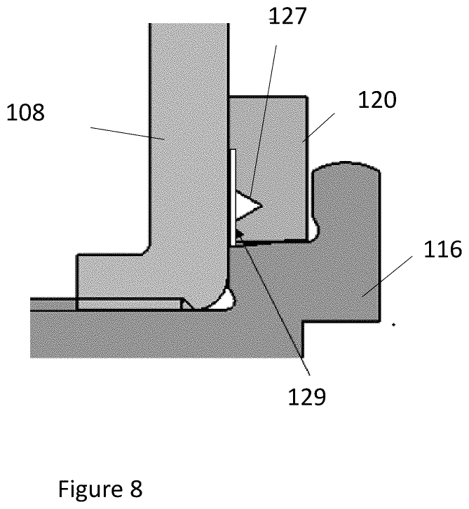

FIGS. 7 and 8 illustrate an example of one of the brackets 120. The bracket 120 includes a generally planar main body 122 having a first surface 124 and a second surface 126. A pivot hole 128, which is a through-hole, extends through the main body 122 from the first surface 124 to the second surface 126.

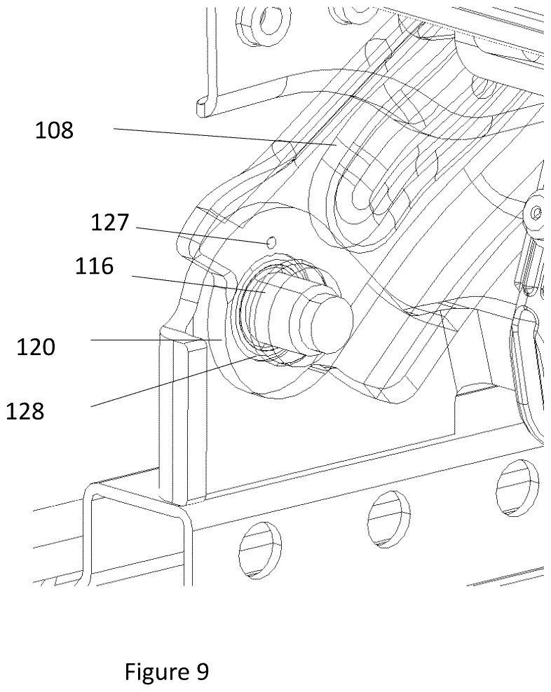

As is illustrated in FIG. 9, the pivot hole 128 is configured to receive a shoulder bolt 116. The shoulder bolt 116 extends through the pivot hole 128 of the bracket 120 and a correspondingly aligned through hole of the rear link 108 to pivotably connect the rear link 108 to the bracket 120. Each rear link 108 and each front link 110 is pivotably attached to a bracket 120 in a similar manner as illustrated in FIG. 9.

A dimple 127 is formed in the first surface 124 adjacent to the pivot hole 128. As is illustrated in FIG. 8, the dimple 127 is a recess extending into the main body 122 of the bracket 120. In the exemplary bracket 120 illustrated in FIGS. 7 and 8, a single dimple 127 is provided. Multiple dimples can be provided around the pivot hole 128. Additionally, in the exemplary bracket 120 illustrated in FIGS. 7 and 8, the dimple 127 is positioned above the pivot hole 128. The dimple 127 may alternatively be positioned at any other point around the pivot hole 128. The dimple 127 should be positioned out of the load path so that dimple does not deform. The dimple 127 is provided adjacent to the pivot hole 128 to mitigate the effects of BSR. The dimple 127 creates a control interference fit that eliminates radial clearance between the shoulder bolt 116 and the hole 128 in the bracket 120.

In the exemplary bracket 120 illustrated in FIGS. 7 and 8, a coined region 129 is formed around the dimple 127. The coined region 129 is a region surrounding the dimple 127 that is stamped into the surface 124 of the bracket 120. The coined region is configured to prevent 129 a clamping condition around the shoulder bolt 116. The coined region 129 is a relief that allows the material the forms the dimple 127 a place the flow, without being trapped under a corner radius of the shoulder bolt 116, which eliminates the potential for a clamped joint.

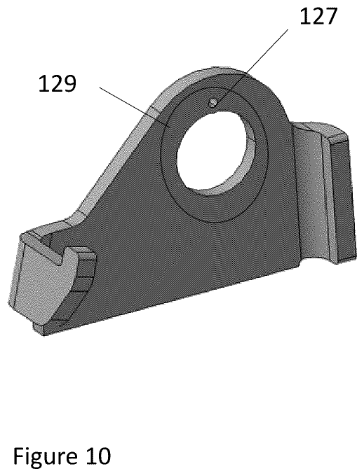

In the exemplary bracket 120 illustrated in FIGS. 7 and 8, the coined region 129 is formed only around the dimple 127. Specifically, the coined region 129 completely/entirely surrounds the dimple 127. Alternatively, the coined region 129 may be formed around an entirety of the pivot hole 128 as illustrated in FIG. 10.

The invention being thus described, it will be obvious that the same may be varied in many ways. Such variations are not to be regarded as a departure from the spirit and scope of the invention, and all such modifications as would be obvious to one of ordinary skill in the art are to be included within the scope of the following claims.

What is claimed is:

1. A bracket for a seat adjustment mechanism of a vehicle seat, the bracket comprising:
a body having a surface;
a pivot hole extending through the body and configured to receive a shoulder bolt for connecting the bracket to the seat adjustment mechanism;
a dimple formed on the surface adjacent to the pivot hole; and
a coined region formed around the dimple.

2. The bracket according to claim 1, wherein the bracket includes a single coined region.

3. The bracket according to claim 1, wherein the bracket includes only one coined region.

4. The bracket according to claim 1, wherein the coined region entirely surrounds the dimple.

5. The bracket according to claim 1, wherein the coined region is formed around the pivot hole.

6. The bracket according to claim 1, wherein the coined region entirely surrounds the pivot hole.

7. The bracket according to claim 1, wherein the coined region is stamped into the surface of the bracket.

8. The bracket according to claim 1, wherein the dimple and coined region are disposed above the pivot hole.

9. A seat adjustment mechanism of a vehicle seat, the seat adjustment mechanism comprising:
a four-bar link, comprising:
an input link;
an intermediate link;
an output link; and
a fixed link;
a bracket, comprising:
a body having a surface;
a pivot hole extending through the body and configured to receive a shoulder bolt for connecting the bracket to the seat adjustment mechanism;
a dimple formed on the surface adjacent to the pivot hole; and
a coined region formed around the dimple.

10. A vehicle seat, comprising:
a seat adjustment mechanism of a vehicle seat, the seat adjustment mechanism comprising:
a four-bar link, comprising:
an input link;
an intermediate link;
an output link; and
a fixed link;
a bracket, comprising:
a body having a surface;
a pivot hole extending through the body and configured to receive a shoulder bolt for connecting the bracket to the seat adjustment mechanism;
a dimple formed on the surface adjacent to the pivot hole; and
a coined region formed around the dimple.

11. A vehicle, comprising:
the vehicle seat according to claim 1.
